(19) United States
(12) Patent Application Publication
(10) Pub. No.: US 2023/0317064 A1
(43) Pub. Date: Oct. 5, 2023

(54) COMMUNICATION SKILLS TRAINING

(71) Applicant: Yoodli, Inc., Seattle, WA (US)

(72) Inventors: Varun Puri, Seattle, WA (US); Esha Joshi, Seattle, WA (US)

(21) Appl. No.: 17/657,730

(22) Filed: Apr. 1, 2022

(51) Int. Cl. G10L 15/18; G10L 25/51; G10L 15/22

(52) U.S. Cl. CPC G10L 15/18; G10L 25/51; G10L 15/22; G10L 2015/225

(57) ABSTRACT

The disclosed communication skills training tool analyzes verbal and vocal content of data relating to a communication event. A user performs in a communication event and the words spoken and characteristics about them are analyzed by the disclosed systems and methods. The analyzed verbal and vocal content is used to develop improved or ideal communication for the user. Recommendation output is generated based on the compared or analyzed verbal or vocal content and on user or third party feedback.

### CROSS-REFERENCE TO RELATED APPLICATIONS

This application is related to U.S. Non-Provisional application Ser. No. ______, entitled, ______,” filed ______, which are incorporated herein by reference in their entirety for all purposes.

### BACKGROUND

Communication can be challenging for many people, especially in pressure situations like public speaking, interviewing, teaching, and debates. Further, some people find communication more difficult in general because of a language difference, a personality trait, or a disability. For example, a nervous person may often use filler words, such as “umm” and “uhh” instead of content rich language during the communication or may speak very quickly. Other people may have a speech impediment that requires practice or may have a native language accent when they wish to communicate with others of a differing native language. Even skilled public speakers without physical or personality barriers to communication tend to develop communication habits that can be damaging to the success of the communication. For example, some people use non-inclusive language or “up talk” (raise the tone of their voices at the end of a statement rather than a question).

Because communication is such a critical skill for success across all ages and professions, some people choose to engage with communication improvement tools such as communication or speech/speaker coaches or skill improvement platforms to help them improve their communication skills. These tools tend to track metrics like pace, voice pitch, and filler words but lack an ability to drive real skill specific growth. Rather, they tend to be good at helping users rehearse specific content but not at improving their underlying communication skills. Such coaches and platforms tend to be communication event specific—rehearsing for a speech, for example—rather than targeting improvement in a particular communication skill. People who engage with these coaches and platforms find they improve their presentation for their intended specific purpose but lack the growth they would like to enjoy by improving the foundational skills that are ubiquitous to all good communication.

What is needed in the industry is a tool for improving communication skills that allows users to enhance their foundational communication abilities.

### BRIEF DESCRIPTION OF THE DRAWINGS

Non-limiting and non-exhaustive embodiments of the invention are described with reference to the following drawings. In the drawings, like reference numerals refer to like parts throughout the various figures, unless otherwise specified, wherein:

FIG. 1 is a flow diagram for training users on communication skills.

FIG. 2 shows a system diagram of an example communication skills training system.

FIG. 3 is a flow diagram of helping users adjust position to improve communication skills.

FIG. 4 is a flow diagram of an example a structure builder for communication content.

FIG. 5 is a flow diagram of an example alpha speech builder for communication content.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The disclosed systems and methods train users to improve their communication skills. Communication is critical to every facet of success in life so it touches all human beings whether they communicate with small groups or in front of large crowds. People suffer from various factors that substantially affect their ability to communicate effectively including stage fright, medical conditions, language barriers, and the like. Some people who wish to improve their communication skills hire expensive communications coaches or spend hours in groups designed to help improve an aspect of communication, such as public speaking. Often, these people who engage in the hard work to improve their communications skills tend to have a particular event in mind for which they wish to prepare. That results in an event-specific outcome for those people.

For example, a person hires a communication coach to help them prepare for an important speech. They practice with the coach for months, working on the structure and content of the speech itself, nervous ticks, bad speaking habits or posture, and the like. At the end of this work, the person has a more polished speech ready to give because of the intense, repetitive practice they did specific to the particular speech to be given and the venue at which it is to be given. The person also might enjoy some incremental improvement in their general communication skills as a result of the immense amount of practice. However, that person was never focused on improving the communication skill itself, but instead was focused on improving the quality of a single speech or communication event. The person might receive feedback from the communication coach that they say filler words or hedging words too often, slouch their shoulders when they become tired, or speak too quickly when they are nervous. However, the coach is unable to given them tangible, data-driven feedback that is focused on verbal, visual, and vocal content of the person's communications skills rather than a single performance.

The disclosed systems and methods provide users with feedback over time on the verbal, visual, or vocal content of their communication skills. Verbal content includes the words actually spoken by the person—the content and its organization. For example, verbal content includes non-inclusive language, disfluencies (e.g., filler words or hedging words), specific jargon, or top key words. Specifically, disfluencies are any words or phrases that indicate a user's lack of confidence in the words spoken. Filler words such as “umm” or “uhhh” and hedging words such as “actually,” basically,” and the like tend to indicate the user is not confident in the words they are currently speaking. Any type of disfluency can be included in verbal content or a grouping of disfluencies multiple types or as a whole category can also be included as verbal content. Visual content includes the body language or physical position, composure, habits, and the like of the user. For example, visual content includes eye contact, posture, body gesture(s), and user background(s)—the imagery of the audience view of the user, the user's motion(s) and movement(s), and their surroundings or ambient environment. Vocal content includes features or characteristics of the user's voice, such as tone, pitch, volume, pacing, and the like. The disclosed system and methods can be powered by artificial intelligence (AI) that compares a current input content to previously stored content—either user stored content or content from a sample, such as a speaker that is excellent in a desired skill of focus for user. Standard AI techniques can be used to compare a current content sample to the existing content. When the current content sample is compared to a user's prior content, the user can begin to learn where they are improving (or not) over time. Their progress can be tracked, and they can set goals and standards they wish to meet based on the comparison of their content to past content.

In the example in which the user's current content is compared to a speaker that has a good communication skill the user wishes to learn, emulate, or adopt, the user's current content can be compared to the exemplary speaker in at least one feature or characteristic, such as tone, up talk, physical presence or position, filler or hedging word rate, or any other verbal, visual, or vocal characteristic.

The user, third parties, or a content analysis algorithm provide feedback to the user on the content provided. The user can input feedback about their own content by replaying the content or adding notes into the disclosed system. Third parties can do the same. The content analysis algorithm also generates feedback from the user's content. This feedback can be asynchronous with or in real-time during the communication event. In some systems, some of the feedback is asynchronous and other feedback is output in real-time to the user. For example, the content analysis algorithm provides real-time feedback to the user while the user reviews the content after the event concludes. Third party mentors and friends can provide their feedback in both real-time and asynchronously in this example.

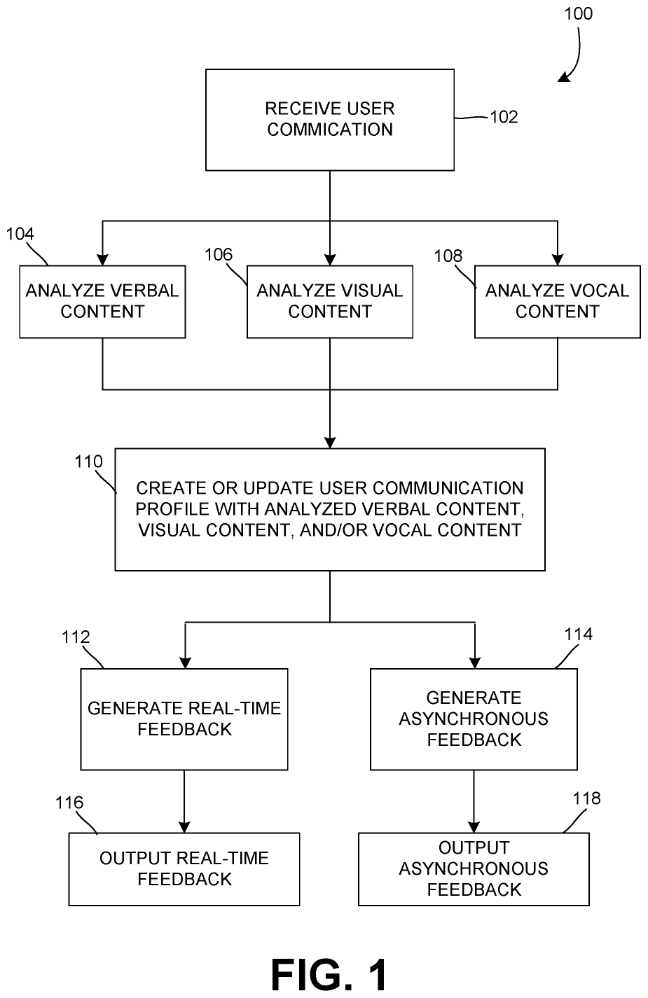

Turning now to FIG. 1, an example communication skills training system 100 receives user communication 102 that can include verbal content, visual content, or vocal content. In some examples, the user communication 102 that the system receives in a combination of multiple types of content. Verbal content includes the substantive words spoken by a user, which can include the user's word choice, such as non-inclusive language, disfluenc(ies), jargon, and top key words. Visual content includes the user's physical position, eye contact quality, posture, gestures or movement, body language, and appearance. Vocal content includes the sound quality and characteristics of the user like the user's voice volume, pitch, and tone, and the user's general speech pacing. The system then analyzes the received user communication by analyzing the verbal content 104, analyzing the visual content 106, or analyzing the vocal content 108, depending on the type of data the system received in the user communication 102.

The system maintains a user profile for each user. In this example, the system creates a new user profile 110 if the user communication relates to a user that is not already stored in the existing system library of user profiles. The system makes this determination is any conventional manner, such as comparing user identification information to user communication data stored for multiple users that have already input user communication data. The system can store any suitable number of user profiles, as needed. When the system determines that received user communication relates to an existing user profile, it updates the user profile 110 with the new user communication in the respective category—verbal content, visual content, vocal content, or some combination of these types of content (correlating with the type(s) of information that was received in the user communication). The update 110 allows the AI algorithm to incorporate the analyzed user communication into the user profile so the system can generate empowered feedback. AI algorithms of any kind can be used for this purpose—any AI technique that is able to discern differences between the existing data set in the user profile and the new data set in the analyzed user communication can be used. Over time, the AI algorithm can discern between increasingly smaller differences between the existing user profile data set and the analyzed data set to fine tune the generated feedback.

After the AI algorithm produces differences between the analyzed data and the existing data set for the user profile, the system then generates either real-time feedback 112 or receives or generates asynchronous feedback 114. The real-time feedback 112 is generated by the system and then output 116 to the user during a live communication event. The real-time feedback 112 can also be received from third parties and integrated with the algorithm feedback in another example. Third parties can include human coaches or other audience members and third party algorithms. The third party data can be output to the user in real-time 116 either integrated or compiled with the algorithm data or as separately output data. In an alternative example, the algorithm is not triggered to active or analyze any user communication data, but instead the third party data is received or analyzed by the system and output to the user in real-time 116.

The asynchronous feedback 114 is generated by the AI algorithm or received from a third party in a similar way to the real-time feedback but is instead output to the user after the communication event ends 118. In this example, the third party feedback may not be analyzed by the system and could simply be passed through and compiled with the AI algorithm feedback or simply output to the user in the form in which it was received by the system.

The user can also input asynchronous feedback to the system about their own communication event, such as a self-reflection or notes for growth or edits to content, for example. In this example, the system can ingest any one or multiple of AI algorithm analyzed data and feedback, third party analyzed data and feedback, or user analyzed data and feedback relating to the user's communication event. Like the real-time feedback, in an example in which asynchronous feedback is received from multiple sources—the AI algorithm, third parties, or the user—the feedback can be analyzed and output 118 separately or can be integrated and analyzed in groups or sub-groups, as needed.

In some example systems, the system can output both real-time 116 and asynchronous feedback 118 to the user in any of the forms of data that was received or analyzed. Here, the system would output the real-time feedback 116 during the communication event and the asynchronous feedback after the communication event 118. The real-time feedback during the communication event can differ from the type and substance of the asynchronous feedback after the event because of the source of the received data (AI algorithm, third party, or user) and the depth or type of analysis performed by the system on the received data.

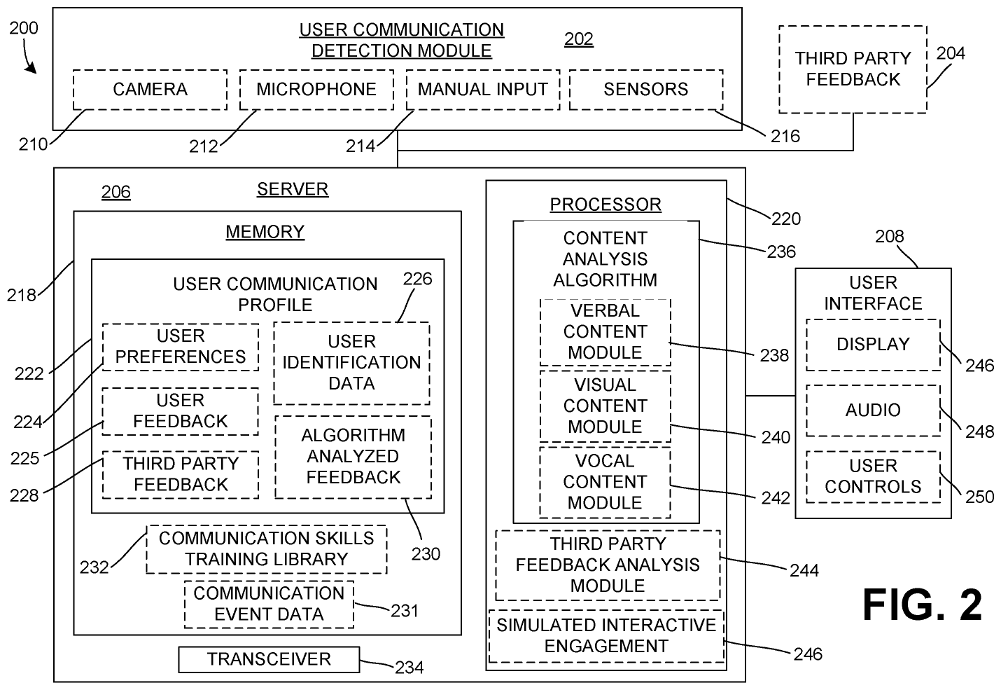

FIG. 2 shows an example communication skills training system 200 that includes a user communication detection module 202, third party feedback 204, a server 206, and a user interface 208. The user communication detection module 202 and third party feedback 204 generate or receive the data that is input to the communication skills training system 200. The user communication detection module 202 includes a camera 210, a microphone, 212, a manual input 214, and one or more sensors 216 in this example. The camera 210 can be any optical imaging component or device. For example, the camera 210 can be an optical imaging device or multiple devices that capture(s) either or both of still and video images of a user during a communication event. The microphone 212 is any suitable device that can capture audio of the user during a communication event. The manual input 214 is any suitable device that can receive input from a user or third party, such as a user interface having any desired feature(s) like text or voice input, touchscreen editing, or other capabilities. The sensor(s) 216 in this system can be any suitable sensor that detects a parameter or feature of the ambient environment of the communication event, such as lighting and image object detection for positioning or other feedback, for example.

The user communication detection module 202 can also include or integrate with third party systems that ingest user data that is transmitted to the communication skills training system 200 shown in FIG. 2. For example, the system 200 integrates with a 3-D video image capture system that captures real-time 3D video or imaging of the user during a communication event. The system 200 may or may not also have its own video capture system. Regardless of the video capture capabilities of the system 200, the system 200 integrates the data received from the third party system—in this case, the 3D video imaging of the user—for analysis and to incorporate into the real-time or asynchronous feedback it generates for the user.

The server 206 of the communication skills training system 200 has a memory 218, a processor 220, and a transceiver 234. The memory 218 stores various data relating to the user, third party feedback, a library of comparison data relating to communications skills training, the algorithms applied to any data received, and any other data or algorithms relating to or used to analyze data regarding training users on communication skills. For example, the memory 218 includes a user communication profile 222 in the system shown in FIG. 2. The user communication profile 222 includes various data relating to a user of the communication skills training system 200. A user communication profile 222 can be created for each user of the communication skills training system 200 in example systems that train multiple users. The user communication profile 22 includes user preferences 224 and user identification data 226. User preferences 224 includes data relating to features, goals, skills of interest, and the like that the user inputs into the system and that may be part of the data analysis that generates feedback in one or more categories or for one or more communication skills. User identification data 226 includes any data that uniquely identifies the user, such as a user's bibliographic information or biometric data for authenticating a user to the system, for example. The user communication profile 218 also includes user feedback 225 and third party feedback 228, which can be received by the communication skills training system 200 either in real-time or asynchronously, as discussed above. Such feedback can include time stamped notes that include observations about or suggestions or recommendations for improvement on a particular segment of a communication event or generalized observations about or suggestions or recommendations for improvement on the overall communication event.

The user communication profile 222 also includes algorithm analyzed feedback 230, as shown in FIG. 2. The algorithm analyzed feedback 230 can be provided in real-time or asynchronously like any of the other feedback provided to the user communication profile 222. The algorithm analyzed feedback 230 includes observations, metrics, and suggestions or recommendations generated by a content analysis algorithm 236, discussed more below, that is part of the communication skills training system 200. As part of the algorithm analyzed feedback 230, the communication skills training system 200 can include a game, such as user challenges regarding a particular communication skill of interest or focus for improvement or practice. The gamefication of improving the user's communication skill of interest or focus can be compared against the user's performance in a previous communication event (or multiple previous communication events) or can be compared against others in a social network or against skilled communicators, such as famous people or experts or any combination of these comparisons.

The memory 218 also includes a communication skills library 232 that can include skilled communicator examples that include data relating to one or more video or image segment(s) of skilled communicators. They can be used to train a user by simply allow a user to replay a video of a skilled communicator, such as a famous person or an expert. This library content 232 can also be used as a comparison tool to evaluate against a communication event of the user. The library content can also include examples of poor communication skills, if desired, to show or evaluate a user's performance on defined objective or created subjective measurements of skill level or improvement or growth.

The processor 220 of the communication skills training system 200 shown in FIG. 2 includes a content analysis algorithm 236, as mentioned above. The content analysis algorithm 236 receives communication event data and analyzes it, such as by identifying certain parameters or characteristics, generating metrics, evaluating or quantifying certain aspects of the data, and the like. In the example shown in FIG. 2, the content analysis algorithm 236 includes a verbal content module 238, a visual content module 240, and a vocal content module 242 that each analyze data relating to respective verbal content, visual content, and vocal content detected by the user communication detection module 202.

For example, the verbal content module 238 can identify top key words or generate a transcript of the communication event. For example, the verbal content module 238 can identify certain words like hedging words (e.g. basically, very, actually, or basically) or non-inclusive words and provide real-time and post-event asynchronous feedback on such metrics. Still further, the verbal content module 238 can identify words that the user emphasizes by pausing or changing the pace of the word as it is spoken, for example. Such verbal metrics can be mapped to a substantive structure of a user's communication event that is either predetermined or generated post-event.

A user could, in an example, upload an outline of key points to address in the communication event. The verbal content module 238 can then map key words it identifies during the communication event to each key point in the uploaded outline and provide metrics to the user either in real-time or post-event regarding the frequency, depth, and other measures relating to the user addressing the key points of the outline. This can also be blended with the verbal content module 238 tracking filler words, such as “uhhh” or “ummm,” either as a standalone metric or in combination with the key points of the outline to see during which of the key outline points the user said more filler words. The verbal content module 238 can measure and analyze any data relating to the content spoken by the user.

The verbal content module 238 can also output reminders in response to tracking the verbal, spoken content. Output reminders can be generated and output to the user in real-time during the communication event. For example, if a user is repeating themselves over a particular allowable threshold—identified in similarity by techniques such as natural language processing or keyword detection—the system 200 then triggers an output to the user during the event that the user should progress to the next topic or point in the communication. In another example, the verbal content module 238 can identify a missed point the user wished to make during the communication event based on an pre-defined set of points the user wanted to address during the communication event. If a missed point is identified by the verbal content module 238, then it generates a user prompt to note the missed point and optionally suggest to the user a time or way to bring up the missed point later during the communication event. The suggestion could be timed based on a similarity of the missed point to another point the user wished to make during the communication event that would be part of the pre-defined set of points the user wanted to address.

Even further, the verbal content module 238 can track a user's point for introduction, topics and sub-topic points, supporting evidence or explanation, and conclusion. This tracking can be done by either comparing the verbal content received with the pre-defined content the user inputs or against common words used for introductions, argument or point explanatory development, and conclusions, for example. The tracking can also be used to help prompt a user to move on to the next phase of the point—move from introduction to explaining detail for a first topic, for example. The system can start by identifying key words typically associated with introductions. If the system tracks that the user speaks too many sequential sentences that include typical introduction key words, then the verbal content module 238 can generate a user prompt to encourage the user to progress to the next portion of the point. This can be accomplished by detecting a number of introduction sentences that exceed a threshold, for example, such as three or more sentences identified as introduction content. When the system detects that the user has exceeded the threshold number of introduction sentences, it triggers a user prompt to progress the content to the next portion of the point.

Still further, the user's pre-defined content, such as speaking notes for example, can be mapped to the user's real-time verbal content. The communication skills training system 200 can display an outline of the pre-defined content that is visually shown as having been addressed or not yet addressed during a communication event. Each point in the pre-defined content can be marked addressed or not addressed during the communication event, which appears on the display seen by the user. The display of this tracking of pre-defined content gives the user a visual cue on the remaining content to discuss during the communication event.

In an example, the verbal content module 238 creates a real-time or post-event transcript of the user's verbal content—the precise, ordered words spoken—during a communication event. If the verbal content module 238 creates a real-time transcript, it can also display it for the user or third parties during the communication event. For the post-event transcript example, the transcript can be edited by the user or a third party and can be optionally displayed in simultaneous play with a video capture replay of the communication event. In some examples, the communication skills training system 200 creates both a real-time and a post-event transcript.

The visual content module 240 can identify visual features or parameters of the user during the communication event, which can include the user's position within a speaking environment for example. The user's position can be on a screen if the communication event occurs virtually or can be within a particular ambient environment for the user during a live event. The visual features or parameters can also include body language and position, such as gestures, head tilt, crossed arms or legs, shoulder shrug, body angling, movements typically associated with a nervous demeanor (i.e., foot or hand tapping, rapid eye movement, etc.), and the like. The visual content module 240 can compare captured frames received from the user communication detection module 202 with prior frames of a similar or time-mapped segment of a prior user communication event. Alternatively or additionally, the visual content module 202 can track visual content throughout the entire communication event and compare it to a prior event, an expert event, or a famous person's prior communication event.

The user communication module 226 stores the communication event data 231 feedback produced by the content algorithm 236 and the third party feedback analysis module 244. Users or third parties can access the stored communication event data 231 about any one or more communication events. For example, the stored communication event data 231 can be video and transcripts of multiple communication events. The user and any authorized third parties can access that stored communication event data 231 to analyze it for feedback. Some examples allow the user or third parties to manipulate the stored communication event data 231 by applying edits or changes to any of the stored communication event data 231 when it is replayed or reviewed, such as removing or decreasing filler words, increasing or decreasing the speed of the user's speech, adding or removing pauses, and the like.

The communication skills training system 200 can also include a simulated interactive engagement module 246. The simulated interactive engagement module 246 includes a simulated person or group of people with whom the user can simulate a live interaction during the communication event. For example, the simulated person could be an avatar or a simulated audience. The content analysis algorithm 236 includes a feature in one or more of its verbal content module 238, visual content module 240, or vocal content module 242 that detects spoken language cues or body language that the system then equates with a likelihood that another person, group of people, or an audience would react in a positive, constructive, or negative manner. For example, if the user is talking too fast (measuring speech speed) or repeating the same point several times (key word detection), the verbal content module 238 would detect the speed of the user's speech or the key word frequency is above a threshold rate or value. If the speed or key word frequency breeches the threshold, the verbal content module 238 generates an avatar or members of a simulated audience, for example, to appear to confused or disengaged. If the user is instead maintaining the speed of their speech within an optimal range and mentioning key words at an optimal frequency, the verbal content module 238 generates the avatar or members of the simulated audience to appear engaged and curious.

The same concept can be applied to the visual content module 240 and the vocal content module 242. The simulated avatar or audience can appear to react in a manner that correlates to the analyzed data relating to the user's body language, position, and movements and also to the users' vocal features and parameters like the user's voice volume, pauses, tone, and the like.

This same simulated interactive engagement module 246 can be useful for training users in multiple types of communication events. The user may wish to practice for an interview, for example with one or more other people. The communication skills training system 200 can receive input from a user about an interview, such as a sample list of topics or interview questions. The simulated interactive engagement module 246 poses the list of questions or topics to the user in a simulated live communication event. As the user progresses through the list of sample questions or topics, the simulated interviewer(s) can be instructed by the simulated interactive engagement module 246 to respond differently depending on the user's metrics in a pervious question or topic. For example, the simulated interactive engagement module 246 tracks key words that a user selected to answer a first question. If the user exceeded a threshold value of the number of times or the variation of the key words used, for example, the simulated interviewer(s) could respond with a pleasant smile or an approving nod.

The transceiver 234 of the server 206 permits transmission of data to and from the server 206. In the example shown in FIG. 2, one or more of the user communication detection module 202, the third party feedback 204, and the user interface 208 can be integrated into a single system. Alternatively, one or more of the components can be a remote component, such as the third party feedback algorithm 204 discussed above or an output that is positioned remote from the memory 218 and processor 220 in a distributed computing environment.

The communication skills training system 200 also includes a user interface 208 that has a display 246, an audio output 248, and user controls 250 in the example shown in FIG. 2. The display can output an image of the user so users are able to view themselves during a communication event. The server 206 generates user prompts or feedback that can be displayed on the output display 246 or output at the audio output 248. The audio can be a speaker in some examples. For example, if the user is speaking too quickly, the verbal content module 238 generates a user prompt and an audio indicator for the user to slow down speech. The user prompt might include a visual or tactical prompt or reminder and the audio output can include a beep or buzz to quickly and discretely prompt the user to slow down. Any combination can also be used. The user interface 208 also includes a set of user controls 250 in some examples. The user controls receive input from a user to input data or otherwise interact with any component of the communication skills training system 200.

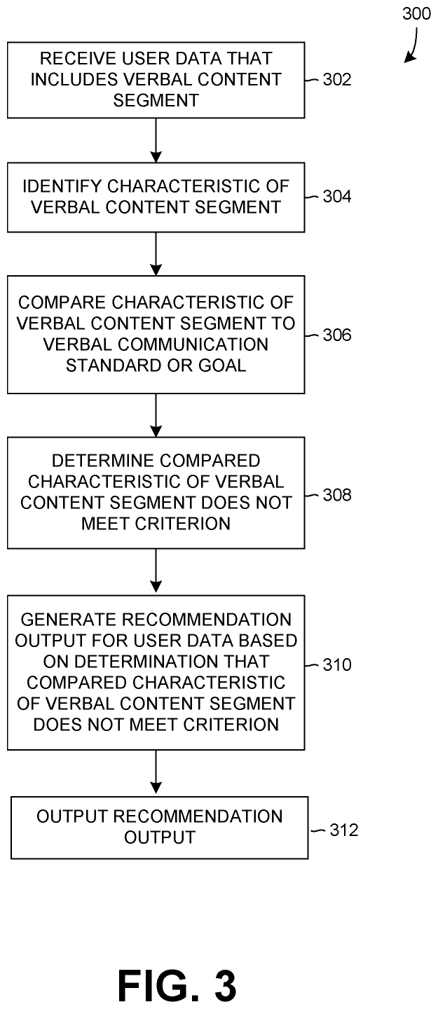

Turning now to FIG. 3, a method of training users to improve communication skills 300 includes receiving using data that includes a verbal content segment 302. As discussed above, the verbal content segment can be received during or after a communication event. The method 300 also identifies a characteristic of the verbal content segment 304. The identified characteristic can be any parameter or characteristic of the user's verbal content. Additionally, the method 300 can include identifying a parameter or characteristic of a user's qualities relating to the user data, such as loudness, tone, pitch, etc. The parameter or characteristic of the verbal content is compared to a verbal communication standard or goal 306. The verbal communication standard or goal can be determined by the user or a third party like a coach or mentor. The verbal communication standard or goal can also be determined by an objective measure, such as a comparison to a communicator who is skilled in a particular communication skill related to the standard or goal or an objective goal or standard defined by an expert communicator.

The characteristic of the verbal content segment can be determined that is does not meet a criterion 308. The criterion can be a set value, such a threshold, or a range within which the measured characteristic ideally should be. The method 300 generates recommendation output based on the characteristic of the verbal content segment being determined not to meet a criterion 308. The output can relate to suggested or recommended improvements to the characteristic of the verbal content segment or a related characteristic. The recommendation output is then output 312, such as to the user or a third party. The recommendation output can be transmitted to a display or a third party, for example.

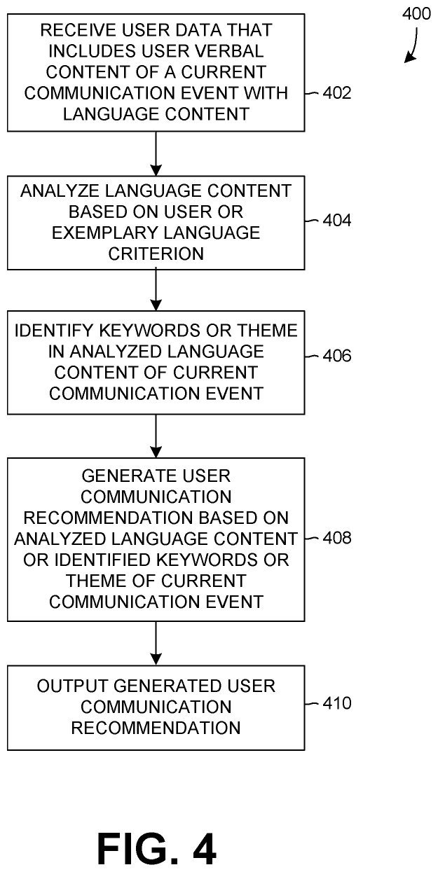

Turning now to FIG. 4, an example structure builder 400 is a method of communication skills training that can be used by a user for a communication event or multiple communication events. The event can be a live or a virtual communication event in which the user's language content is recorded or tracked by audio or video. The communication event(s) can be a single instance in which a user wishes to analyze their communication based on a user criterion or an exemplary language criterion or can be multiple events for the user to gain knowledge of skill growth over time. A single communication event analysis can analyze a user's communication to provide recommendations based on the single event only, which can include the structure of the user's spoken language, for example. In this case, the recommendation could include an analysis of the language content spoken by the user, such as analysis of the structure of the topics or themes about which the user spoke during the communication event like introductions, rules, analysis, and conclusions. Identification of the user's language content can be identified by analyzing it for keywords or using NLP to identify the intent or content of the spoken language.

This language data can be transformed into a structure of the user's communication event, such as an outline, virtual “flashcards,” etc. Such structure can be used by the user and by third parties to help improve the overall substantive messaging presented by the user. The structure can be output to the user in a subsequent communication event in real-time. For example, the structure builder 400 can develop an outline of the language content from a current communication event. The outline can then be displayed on a screen for a user during a subsequent communication event. The outline can also be transformed into virtual flashcards that display each topic in a desired sequence with an option to highlight high priority topics, add notes and reminders in particular sections of the language content, or the like. In the subsequent communication event, the user's subsequent language content can be compared to the outline language content or the flashcards and analyzed to determine if the sequence and content are altered or improving. If the user failed to address a topic in sequence according to the outline, for example, the structure builder 400 could then output an altered outline during the subsequent communication event that the user is out of sequence on that event or that the topic was not addressed yet so the user can address it later in the presentation. Additionally, the structure builder 400 can suggest a timing for addressing a missed topic later in the presentation based on certain criteria like a similarity of the keywords related to each topic, for example.

In another example, a user introduces a topic, states a rule or hypothesis, and then includes only a single sentence next before concluding the topic. The structure builder 400 can identify that sequence of spoken language by NLP technique that extracts or keyword identification in the language content transcript to make recommendations on how to improve the section of the user's presentation relating to explaining the analysis of the proposed topic. Additionally, the structure builder 400 can also assign a relative weight to a language content segment, such as the volume or length of a user's introduction compared to the user's rule statement or analysis of the topic. If the relative weight is consistent with either the user's identified criterion or an exemplary criterion for the relative weight or volume of an introduction compared to the rule or analysis, for example, then the recommendation could be positive output that the user spent the appropriate amount of time on each section of the topic. However, if the user spent a lot of time repeating introductory concepts compared to the amount of time developing the concept analysis, then the recommendation could be to reduce the introduction with feedback regarding the repetitive introduction language.

Alternatively, the structure builder 400 could analyze an entire language content of the communication event and assign segments to a category or type. For example, the language content could be categorized by introduction, rule, analysis, and conclusion. The categorization of language content can be analyzed for proper sequencing in some examples, such as determining whether the user followed a gold standard or user set standard for a logical progression of presenting an idea to another person or audience. The categorization of language content can also be used to determine a relative percentage or portion of the overall communication event that the user spends on a particular category. For example, an ideal percentage for analysis of a topic could be 45% of the user's time. If the user spends only 15% of the time speaking on the analysis, then the structure builder could output an alert to the user—in real-time—or could output the recommendation after the event to encourage the user to spend more time developing the topic analysis during the next communication event.

Still further, the categorization can be used to assign a relative weight to the various sections of the user's language content during a communication event. For example, if the structure builder 400 determines through keywords or NLP analysis that the user has a very short conclusion (less than an ideal) yet did an excellent rule statement and topic analysis (proper length and depth of explanation), the structure builder 400 can weight the rule statement and topic analysis as more important sections or categories than the conclusion. The same type of weighting can occur with assigning a higher weight to a core topic that is a high priority to thoroughly explain compared to assigning a lower weight to ancillary topics that the user could choose to explain in less detail or leave out of the communication.

The structure builder 400 can also score various language content of the user from a communication event. The scoring can be a score related to an individual skill or can be a compiled score for overall performance of performance in a particular section of the communication event or for a subset of skills identified by the user or a third party. The structure builder 400 could adjust scoring of multiple skills based on an assigned weight of the particular skill in the multiple skills. For example, core competency skills, such as developing a logical sequence of topics during the communication event could be weighted greater than a skill of having an introduction focus within a pre-defined length or range. Scoring can include comparing the user's language content against other users in a gamefication approach that induces a sense of social connection with other users and a spirit of competition to perform well compared to other users. Scoring can also be an more objective, individual process in which the structure builder 400 receives user input regarding a performance level the user wishes to achieve during the communication event. The user or the structure builder 400 can objectively define the desired performance level the user wishes to achieve based on objective criteria input by the user, such as a list of priority skills on which the user wishes to focus for growth. The performance level can also be set by gold standards, such as those conventionally recommended by communication experts or those set by communication coaches, mentors, or other third parties.

A language content analysis could also be done to identify when a user is repeating introduction concepts, lacking clarity in stating a rule for a topic, failing to conclude a topic, or the like. The structure builder 400 can analyze the data in a similar manner to identify sections that are too long in proportion to other sections, according to either an objective or a user-identified standard or criterion using any suitable language analysis techniques like NLP or keyword identification in transcripts.

The structure builder 400 can perform the language content analysis in real-time or as a post-event action. If the structure builder 400 performs the language content analysis in real-time, it can also output the recommendation or a progressive structure of the user's language content to the user in real-time. The recommendation can include the output structure, such as the progressive structure for the real-time example.

The structure builder 400 includes receiving user data that includes user verbal content of a current communication event 402. The verbal content of the current communication event includes language content. The language content includes the substantive words spoken by the user. In some examples, the structure builder 400 considers only a current communication event while in other examples, the structure builder 400 considers content from multiple communication events. The user decides on a criterion on which to analyze the user data and more specifically, on which to analyze the language content. The criterion can be related to anything about the user's language content like overall presentation organization, development of themes or analysis of topics presented, logical flow of connection between topics, repetitive language, and the like. The user can set this criterion or can choose to analyze the user's communication event to exemplary or ideal communication events of others 404. Sometimes, the structure builder 400 can analyze the language content using both user criterion and exemplary criterion. Exemplary criterion can come from objective standards, such as a gold standard of speech structure or topic development, or from a more subjective source like a third party mentor or coach that targets a particular language content goal for the user.

The structure builder 400 can identify keywords or a theme in the analyzed language content of the current communication event 406. As discussed above, the structure builder 400 can generate a transcript of the user's spoken language, which is analyzed for particular keywords. The keywords could change as the user progresses through the communication event, depending on the topic being address or the section of the communication on which the user is actively speaking. For example, the keywords for a first topic differ from the keywords related to a second topic. Further, as a user progresses through a communication event, keywords to detect a user is introducing a topic differ from keywords to detect a user is actively developing the rule or the analysis for the same topic. When the structure builder 400 analyzes multiple communication events, it can generate robust data on each of these, such as precise keywords with targeted timing, content development, and the like. Every time a new communication event is entered, the structure builder 400 can discern smaller differences between the existing language content and the new current communication content.

The structure builder 400 generated a user communication recommendation based on the analyzed language content or the identified keywords or the theme of the current communication event 408. The user communication recommendation relates to any skill, metric, or content analysis of the language content of the communication event. The user communication recommendation can include feedback related to a single communication event or multiple communication events. In some examples, the feedback includes metrics about the user's language content in the current communication event along with tracked data of similar metrics that are analyzed over multiple communication events.

The communication recommendation can be in any suitable form, such as a user alert or structure builder language content transcript, that can be output in real-time during the current communication event or as a post-event feedback. As discussed above, the user's language content can be tracked and analyzed by the structure builder to form an outline or content analysis of the user's analyzed language content. If, for example, the user has been practicing content for the same communication event multiple times, the current communication event data can be analyzed to determine if the user addressed all relevant topics covered in previous events, if the user spent the same/less/more time on a particular category of language content, if the user addressed all high priority topics, and the like.

The communication recommendation includes analyzed data, which can include recommendations to alter an aspect of the user's communication skills or language content. For example, the keywords identified through analysis of the transcript or through NLP conclude that the user addressed topics out of sequence from a recommended standard. The structure builder 400 could generate a content organization recommendation that the user alter a content organization of the language content in this example. In another example, the structure builder 400 could identify through analysis of the transcript or through NLP that a user did not spend enough time developing a robust analysis of a high priority topic. The structure builder 400 could then generate a content development recommendation that the user spend more time talking about the analysis of the high priority topic or simply identify that the user spent little time on the high priority topic analysis in the current communication event.

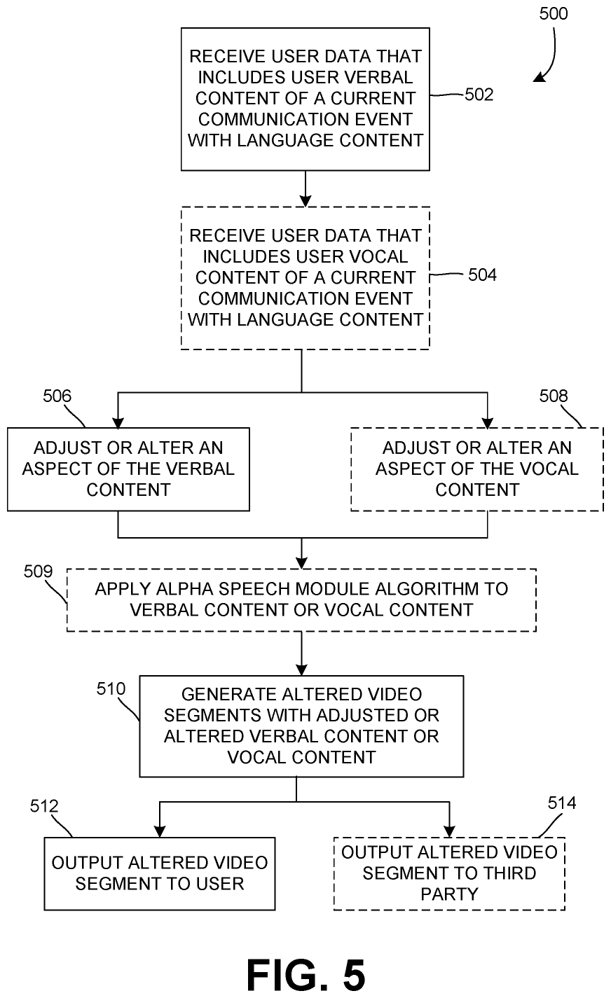

Turning now to FIG. 5, an alpha speech builder 500 is shown that also analyzes the verbal content 502 and the language content that the structure builder 400 analyzes. Additionally, the alpha speech builder 500 analyzes all verbal content including the language spoken, as the structure builder 400 analyzes, but also can analyze vocal content 504, such as the user's voice characteristics like tone, pitch, and loudness. The alpha speech builder 500 relies on keyword analysis or NLP of the language content to produce a video segment of the user's communication event. The alpha speech builder 500 then receives user or third party input related to the video segment that adjusts or alters one or more skills the user practiced during the communication event 504. The adjustment or alteration can be in the form of deleting a particular repetitive language content, like filler words, lengthy introductions, and the like. The adjustment can also be in the form of adjusting or altering the speed at which the user speaks during the video segment, such as slowing down or speeding up sections. For example, a user can alter the speed of a selected portion of the video segment to speed it up or slow it down—this the user can alter the replay speed to various levels to identify the user's preferred speed or to adjust it to be consistent with gold standards on communication or third party feedback or coaching. The alpha speech builder 500 can adjust or alter any skill, parameter, or aspect of the user's verbal content or vocal content in the video segment or can adjust multiple skills to allow a user to fine tune the combination of skills to adjust in various combinations.

In another example, the verbal content can have a first portion and a second portion. The user or a third party can alter one or the other of the first portion and the second portion. The user communication recommendation is generated by the alpha speech builder 500 based on the altered aspect of the first portion or the second portion that is altered. The altering can be done by the user or by a third party or can be a combination of adjustments suggested by both the user and a third party. The alpha speech builder 500 can produce multiple versions of the video segment or verbal content of the user that can be shared and continuously altered or adjusted by the user or third parties.

The alpha speech builder 500 can also generate one or multiple altered video segments that incorporate one or more adjustments 510. The alpha speech builder 500 can then output the one or multiple altered video segments to the user 512 or optionally to a third party 514 or a group of third parties. The user and any third parties can then view the altered video and provide additional feedback to the user. In some examples, the alpha speech builder 500 processes multiple rounds of adjustments and alterations to the user verbal or vocal content.

In an example, a first portion of a verbal segment includes substantive language content the user identified as a high priority to address during the communication event. A second portion of the verbal segment includes filler words. The alpha speech builder 500 allows a user to view a video segment of the user's communication event and alter the speech of the video replay of the user speaking the fillers words by increasing the speed of the second portion with the filler words to be multiples faster—in some instances up to 5 times faster or more—than the speed of the first portion with the substantive words. This replay speed differential produces an emphasis for the listener—a person or an audience—on the first portion with the substantive words instead of equal emphasis on the first portion and the second portion because the first portion is replayed at a speed of normal speaking while the second portion is replayed at a speed that may be too fast to process by a human listener or may be unintelligible. The replay speed differential between the first portion and the second portion gives the user an idea of what the user's communication skills would be like with less of an emphasis on the filler words and a greater emphasis on the substantive words.

In another example, the first portion includes the user speaking at a voice inflection that is consistent with a sentence while the second portion includes up talk in which the user's voice inflection rises at the end of a sentence rather than a question. The user can adjust the video segment to cause the user's voice in the second portion to have the same inflection as the first portion or to have an exemplary inflection. Alternatively, the user can adjust the video segment so that a voice over of another person with similar voice qualities to the user speaks the words without the up talk so the user can imagine what they would sound like without the uptalk included.

In still another example, the first portion of the user's verbal content includes non-inclusive speech while the second portion includes substantive speech. The alpha speech builder 500 can allow the user the ability to alter the first portion by removing the non-inclusive speech, deleting and inserting inclusive speech for the non-inclusive speech, speeding up the non-inclusive speech to be unintelligible, or any other way to create a video replay that allows the user to hear or emphasize the second portion without the non-inclusive speech that is included in the first portion.

The alpha speech builder 500 can include any number of these altered portions from the user or any one or multiple third parties. Alternatively or additionally, the alpha speech builder 500 can include an alpha speech module 509 that is an algorithm that detects and identifies such alterations. Such an alpha speech module 509 could automatically identify filler words, for example, from a keyword or NLP analysis of the transcript of the communication event. The alpha speech module 509 would then automatically apply a filter to speed up the portion of the verbal content that includes the filler words. Alternatively, the alpha speech module 509 would prompt a user to apply a filler words removal filter to the replay video to remove the filler words.

Though certain elements, aspects, components or the like are described in relation to one embodiment or example, such as an example diagnostic system or method, those elements, aspects, components or the like can be including with any other diagnostic system or method, such as when it is desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents.

What is claimed is:

1. A method of training user communication, comprising:
receiving user data that includes user verbal content of a current communication event, the verbal content of the current communication event includes language content;
analyzing the language content of the user verbal content based on a user or exemplary language criterion;
identifying keywords or a theme in the analyzed language content of the current communication event;
generating a user communication recommendation based on the analyzed language content or the identified keywords or the theme of the current communication event; and
outputting the generated user communication recommendation.

2. The method of claim 1, wherein the user verbal content includes video or audio content of a user during the current communication event.

3. The method of claim 1, further comprising identifying keywords or a theme in the language content of the user verbal content, and wherein the user or exemplary language criterion is based on the identified keywords or the theme in the language content.

4. The method of claim 3, further comprising generating the user communication recommendation based on the identified keywords or the theme.

5. The method of claim 3, further comprising analyzing the language content of the user verbal content based on the identified keywords or the theme in the language content.

6. The method of claim 5, further comprising analyzing the language content of the user verbal content with natural language processing.

7. The method of claim 5, further comprising analyzing the language content of the user verbal content by generating a transcript of the language content and analyzing the transcript for the identified keywords or the theme.

8. The method of claim 5, wherein the keywords or the theme in the language content indicates that the language content indicates a content introduction, a content rule, a content analysis or a content conclusion.

9. The method of claim 8, wherein the language content indicates at least two of the content introduction, the content rule, the content analysis, and the content conclusion, and further comprising assigning a relative weight to the at least two of the content introduction, the content rule, the content analysis, and the content conclusion.

10. The method of claim 9, wherein the user or exemplary language criterion includes an exemplary relative weight of at least two of the content introduction, the content rule, the content analysis, and the content conclusion, and further comprising generating the user communication recommendation based on the analyzed language content or the identified keywords or the theme by comparing the relative weight of the at least two of the content introduction, the content rule, the content analysis, and the content conclusion to the exemplary relative weight.

11. The method of claim 5, further comprising generating the user communication recommendation to include language structure feedback.

12. The method of claim 11, wherein the language structure feedback includes an exemplary recommendation to alter a content organization or a content development of the language content.

13. The method of claim 5, further comprising:
generating a user prompt that includes the identified keywords or the theme in the language content,
storing the user prompt, and
instructing that the user prompt is output during a subsequent communication event.

14. The method of claim 13, further comprising:
analyzing the generating a user alert if the identified keywords or the theme in the language content are not included in user verbal content of the subsequent communication event.

15. The method of claim 13, further comprising generating a user alert when the identified keywords or the theme in the language content are included in user verbal content of the subsequent communication event.

16. The method of claim 13, further comprising:
analyzing user data that includes user verbal content of the subsequent communication event, the verbal content of the subsequent communication event includes language content, and
identifying the keywords or the theme are present in the analyzed user data that includes the user verbal content of the subsequent communication event, and
generating the user communication recommendation based on the presence of the analyzed user data that includes the user verbal content of the subsequent communication event.

17. The method of claim 13, further comprising:
analyzing user data that includes user verbal content of the subsequent communication event, the verbal content of the subsequent communication event includes language content, and
identifying the keywords or the theme are absent in the analyzed user data that includes the user verbal content of the subsequent communication event, and
generating the user communication recommendation based on the absence of the analyzed user data that includes the user verbal content of the subsequent communication event.

18. The method of claim 1, further comprising:
identifying a first portion of the verbal content and a second portion of the verbal content,
altering an aspect of the first portion of the verbal content or the second portion of the verbal content, and
generating the user communication recommendation to include the altered aspect of the first portion of the verbal content or the second portion of the verbal content.

19. The method of claim 18, wherein altering the aspect of the first portion of the verbal content or the second portion of the verbal content includes altering a replay speed of the first portion or the second portion.

20. The method of claim 19, wherein the first portion includes a substantive word and the second portion includes a filler word, and further comprising increasing the replay speed of the second portion.

21. The method of claim 1, wherein analyzing the language content of the user verbal content is based on the user language criterion that includes user determined alpha speech.

22. The method of claim 1, wherein analyzing the language content of the user verbal content is based on the exemplary language criterion that includes objectively determined alpha speech.

23. The method of claim 1, wherein analyzing the language content of the user verbal content includes:
identifying a frequency of filler words, non-inclusive speech, or up talk, and
determining that an aspect of the identified frequency of the filler words, non-inclusive speech, or up talk does not meet a criterion, and
generating the user communication recommendation to include the determination of that an aspect of the identified frequency of the filler words, the non-inclusive speech, or the up talk does not meet the criterion.
